(19) United States
(12) Patent Application Publication
(10) Pub. No.: US 2026/0347629 A1
(43) Pub. Date: Nov. 5, 2026

(54) POLYMERIC BROMINATED FLAME RETARDANT COMPOSITION FOR USE IN WIRE AND/OR CABLE

(71) Applicant: ALBEMARLE CORPORATION, Charlotte, NC (US)

(72) Inventors: Raghunath ROY; Rajeev S. MATHUR; Jonathan p. MCCARNEY; Wayne HUBERTY

(73) Assignee: ALBEMARLE CORPORATION, Charlotte, NC (US)

(21) Appl. No.: 19/486,945

(22) PCT Filed: May 22, 2024
(86) PCT No.: PCT/US2024/030499

§ 371 Date: Nov. 23, 2025

Related U.S. Application Data
(60) Provisional application No. 63/503,798, filed on May 23, 2023.

(51) Int. Cl. C09D 7/65; B29C 48/00; B29C 48/154; B29K 23/00; B29K 83/00; B29K 105/00; B29K 105/24; B29K 425/00; B29L 31/34; C08K 3/22; C08K 5/00; C08K 5/14; C08L 23/06; C08L 23/0869; C08L 25/18; C08L 83/04; C09D 7/61; C09D 123/06; C09D 123/08; C09D 183/04

(52) U.S. Cl. CPC C09D 7/65; B29C 48/022; B29C 48/154; C08K 3/2279; C08K 5/005; C08L 23/06; C08L 23/0869; C08L 25/18; C08L 83/04; C09D 7/61; C09D 123/06; C09D 123/0846; C09D 183/04; B29K 2023/0633; B29K 2023/083; B29K 2083/00; B29K 2105/0026; B29K 2105/246; B29K 2425/06; B29K 2995/0016; B29L 2031/3462; C08K 5/14

(57) ABSTRACT

This invention relates to flame retardant compositions and to polymeric brominated flame retardant compositions for use in wire and/or cable. The brominated flame retardants contain aromatically bound bromine, and in several embodiments are considered to be brominated styrenic polymers. The brominated flame retardants have weight average molecular weights (Mw) of about 650 to about 75,000 and a bromine content of about 60 wt % or more. This invention further relates to a process for forming a flame retardant composition utilizing different curing methodologies including but not limited to e-beam and peroxide curing

### CROSS-REFERENCE TO RELATED APPLICATION

This application claims the benefit of U.S. Provisional Patent Application Ser. No. 63/503,798, filed May 23, 2023, and PCT/US2024/30499 filed May 22, 2024, and PCT/US2024/30523 filed May 22, 2024, the disclosure of which is incorporated herein by reference in its entirety.

### TECHNICAL FIELD

This invention relates to flame retardant compositions and to polymeric brominated flame retardant compositions for use in wire and/or cable.

### BACKGROUND

Conduit, appliance, or automotive wires and cables often only have one polymer layer. This layer must fulfil several functions at the same time, which in other low voltage cables, medium and high voltage cables are fulfilled by separate layers. Accordingly, a polymer composition used for the production of conduit, appliance, or automotive wires, must meet several demanding requirements at the same time, including good insulation behavior, good mechanical properties, in particular good abrasion resistance, good flame retardant properties, good heat deformation resistance, ability to withstand cold temperatures, resistance to water and chemicals as well as good processing properties.

Many plastics, including polyolefins, are flame retarded to minimize the spread of fire. In WO 2005/095685 and WO 2022/031932, polybrominated anionic styrenic polymers are used to flame retard polyolefins, in conjunction with at least one synergist; WO 2001/029124 discloses polyolefins with flame retardants, which include the bis(2,3-dibromopropyl ether) of tetrabromobisphenol-A and the bis(2,3-dibromopropyl ether) of tetrabromobisphenol-S. In U.S. Pat. No. 6,780,348, combinations of a polybromodiphenylalkane and a tetrabromobisphenol-A-bis(bromoalkyl ether) are disclosed. U.S. Pat. Nos. 8,476,373 and 8,933,159 are directed to brominated anionic chain transfer vinyl aromatic polymers, which can flame retard polyolefins.

Fire retardants are used in wire and/or cable formulations to attain the flame performance required for the specific application such as appliances, building and construction, cables in automotives, photovoltaic wires, etc. In these applications, the insulation coating over the conductor is made to be flame retardant by incorporating various fire-retardant chemistries or technologies (Bromine, Phosphorus, Metal hydroxide (e.g., . . . , magnesium hydroxide, aluminum hydroxide, etc.). Such fire-retardant chemistries are also used in the jacket (layer on top of insulation) formulation. The insulation or jacket could be (1) thermoplastic or (2) thermoset (crosslinked).

Non-limiting examples of thermoplastics for insulation or jacket include polyurethanes, polyesters, polyamides, polyolefins, styrenic polymers, chlorinated polyethylene, and combinations thereof.

Thermoset formulations for wire and/or cable are commonly formed by crosslinking technologies including (a) Moisture cure, (b) Peroxide cure, or (c) E-beam cure technologies. Non-limiting examples of base polymers suitable for cross-linking include polyolefins, such as polyethylene, and polyolefin copolymers such as poly(ethylene-vinyl acetate) (EVA) and poly(ethylene ethyl acrylate) (EEA), as well as derivatives of polyolefins such as chlorinated polyethylene or silane functionalized polyethylene.

The existing non-polymeric brominated flame retardants (BFRs) often have higher melting temperatures than the process conditions, and need to be milled to a very small and uniform particle size (average less than about 10 microns) before they can be used in a wire and/or cable formulations. Higher particle sizes would negatively impact the smoothness of the wire insulation surface. In addition to an expensive and/or time-consuming milling process, non-polymeric BFRs often generate high extrusion back pressure during compounding.

Therefore, the art continually looks for improved flame retardant compositions for use in wire and/or cable.

### SUMMARY OF THE INVENTION

This invention provides flame retardant compositions including thermoplastics for use in wire and/or cable. Non-limiting examples of thermoplastics include polyurethanes, polyesters, polyamides, polyolefins, styrenic polymers, chlorinated polyethylene, and combinations thereof. The flame retardants are brominated polymeric flame retardants. The polymeric brominated fire-retardants (PBFRs) are based on polystyrene backbone and synthesized by aromatic bromination process. These PBFR formulations are suitable for various wire and/or cable applications offering unique properties that were not possible before by the existing brominated fire-retardant technologies.

Another embodiment of this invention provides flame retardant compositions including thermoset formulation for use in wire and/or cable. Thermoset formulations for wire and/or cable are commonly formed by crosslinking technologies including (a) Moisture cure, (b) Peroxide cure, or (c) E-beam cure technologies. Non-limiting examples of base polymers suitable for cross-linking include polyolefins, such as polyethylene, and polyolefin copolymers such as poly(ethylene-vinyl acetate) (EVA) and poly(ethylene ethyl acrylate) (EEA), as well as derivatives of polyolefins such as chlorinated polyethylene or silane functionalized polyethylene. The flame retardants are brominated polymeric flame retardants. The polymeric brominated fire-retardants (PBFRs) are based on polystyrene backbone and synthesized by aromatic bromination process. These PBFR formulations are suitable for various wire and/or cable applications offering unique properties that were not possible before by the existing brominated fire-retardant technologies.

Other embodiments of the invention include processes for preparing the flame retardant compositions and flame retarded thermoplastic or thermoset compositions of the invention and their use as coatings for wire and/or cable.

These and other embodiments and features of this invention will be still further apparent from the ensuing description and appended claims.

### FURTHER DETAILED DESCRIPTION OF THE INVENTION

The benefits of the present brominated polymeric flame retardant are numerous. For example, existing non-polymeric BFRs have higher melting temperature than the process condition. Thus, a non-polymeric BFR needs to be milled to a very small and uniform particle size (average less than about 10 microns) before it can be used in a wire and/or cable formulation. However, the polymeric flame retardant of the present invention has a glass transition temperature (Tg) lower than the typical wire and/or cable process temperature (Tg less than about 145 °C vs. process temperatures of about 200 °C). Thus, at the process temperatures, the polymeric BFR would readily melt-blend and mix with the other ingredients of the formulation.

Further, unlike the existing polymeric and non-polymeric BFRs, the new polymer BFR formulations of this invention offer lower extrusion back pressure during compounding and wire extrusion process due to their higher melt index (higher melt index means polymer flows better at a given pressure and temperature). Thus, it allows compounder and the cable producer to extrude at higher through-put (lb/hr, or meter/hr).

Unlike previously disclosed polymeric BFRs, the polymeric brominated flame retardants of this invention offer higher thermal stability. The polymeric BFRs claimed in other inventions to be used in wire and/or cable application are often aliphatic brominated polymers as opposed to polymeric BFR of this invention where the bromine is attached to aromatic ring. The aromatic bromine has higher thermal stability than aliphatic bromine. Higher thermal stability means one can (a) use the formulation at higher processing temperatures, (b) have longer run time during wire coating and (c) have the possibility for enhanced recyclability.

The brominated flame retardants in the practice of this invention contain aromatically bound bromine, and, in several embodiments, are considered to be brominated styrenic polymers. The brominated flame retardants have weight average molecular weights (Mw) of about 650 to about 75,000 and a bromine content of about 60 wt % or more. Preferably, the styrenic polymers are polystyrenes. Mixtures of two or more brominated flame retardants can be used in the practice of this invention. Mixtures of brominated flame retardants and other non-halogenated flame retardants can also be used in practice of this invention.

In other embodiments, the brominated flame retardants are brominated anionic styrenic polymers, in which the styrenic polymers were formed via anionic polymerization, typically with an alkyl lithium initiator; these brominated flame retardants generally have a weight average molecular weight (Mw) of about 2000 or more, preferably about 10,000 or more. In some embodiments, the brominated anionic styrenic polymers have a Mw of about 8000 to about 50,000, preferably about 10,000 to about 30,000, and more preferably about 10,000 to about 20,000.

Typically, the brominated anionic styrenic polymers contain about 60 wt % or more bromine, preferably about 66 wt % or more bromine, more preferably about 67 wt % or more bromine. In some embodiments, the brominated anionic styrenic polymers contain about 60 wt % to about 72 wt % bromine, more preferably about 66 wt % to about 71 wt % bromine, even more preferably about 67 wt % to about 71 wt % bromine. Preferably, the brominated anionic styrenic polymer is a brominated anionic polystyrene. In some embodiments, the brominated anionic styrenic polymers are brominated anionic polystyrene having a weight average molecular weight of about 10,000 to about 20,000, and about 67 wt % to about 69 wt % bromine. Information on the preparation of brominated anionic styrenic polymers is found for example in U.S. Pat. Nos. 7,632,893 and 7,638,583.

In another embodiment, the brominated flame retardant is a low molecular weight brominated anionic styrenic polymer having a weight average molecular weight (Mw) of about 650 or more, preferably about 950 or more, more preferably about 1000 or more. In some embodiments, these brominated anionic styrenic polymers have an Mw in the range of about 650 to about 10,000, preferably about 750 to about 7500, and more preferably about 1000 to about 4000.

Typically, the low molecular weight brominated anionic styrenic polymers contain about 60 wt % or more bromine, preferably about 66 wt % or more bromine, more preferably about 70 wt % or more bromine. In some embodiments, these brominated anionic styrenic polymers contain about 60 wt % to about 77 wt % bromine, preferably about 66 wt % to about 77 wt %, more preferably about 70 wt % to about 75 wt % bromine.

Preferably, the low molecular weight brominated anionic styrenic polymers are brominated anionic polystyrenes. In some embodiments, the low molecular weight brominated anionic styrenic polymers are brominated anionic polystyrenes having a weight average molecular weight of about 1000 to about 3000, and about 73 wt % to about 77 wt % bromine.

The low molecular weight brominated anionic styrenic polymers can be formed by bromination in an organic solvent or in a sea of bromine (in which bromine is both the brominating agent and the solvent). Information on the preparation of low molecular weight brominated anionic styrenic polymers is found for example in International Patent Publications WO 2017/176740 and WO 2017/184350; these polymers can also be made as described U.S. Pat. Nos. 7,632,893 and 7,638,583.

Another brominated flame retardant that can be used in the practice of this invention is sometimes not categorized as a styrenic polymer due to the relatively small number of repeating units in these molecules. Similar to the brominated styrenic polymers, these molecules also contain aromatically-bound bromine, and styrenic repeating units. This brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more. In some embodiments, the bromine content is in the range of about 70 wt % to about 79 wt %, preferably about 72 wt % to about 78 wt %, and the Mw is in the range of about 1000 to about 21,000, preferably about 1250 to about 14,000, more preferably about 2000 to about 10,000.

Preferably, the brominated anionic chain transfer vinyl aromatic polymers are brominated anionic chain transfer polystyrenes. In some embodiments, the brominated anionic chain transfer vinyl aromatic polymers are brominated anionic chain transfer polystyrenes having a weight average molecular weight of about 2000 to about 10,000, and about 72 wt % to about 78 wt % bromine.

The brominated anionic chain transfer vinyl aromatic polymers can be formed by bromination in an organic solvent or in a sea of bromine (in which bromine is both the brominating agent and the solvent). Information on the preparation of brominated anionic chain transfer vinyl aromatic polymers is found for example in U.S. Pat. Nos. 8,420,876, 8,796,388, and 8,993,684.

Mixtures of two or more brominated flame retardants can be used in the practice of this invention. In addition to the brominated anionic styrenic polymers and/or brominated anionic chain transfer vinyl aromatic polymers, the flame retardant additive compositions can contain one or more other brominated flame retardants. Suitable brominated flame retardants include hexabromocyclohexane, dibromoethyldibromocyclohexane, monochloropentabromocyclohexane, tetrabromocyclooctane, hexabromocyclododecane, bis(pentabromophenyl)ethane (decabromodiphenyl ethane), hexabromobenzene, dibromostyrene and derivatives thereof, pentabromodiphenyl oxide, octabromodiphenyl oxide (octabromodiphenyl ether), decabromodiphenyl oxide (decabromodiphenyl ether), 1,2-bis(tribromophenoxy)ethane, tetradecabromodiphenoxybenzene, 2,4,6-tribromophenol allyl ether, dibromoneopentyl glycol, tribromoneopentyl alcohol, tetrabromobisphenol-A, tetrabromobisphenol A diallyl ether, tetrabromobisphenol-A bis(2,3-dibromopropyl ether), bis(2,4,6-tribromophenoxyethyl) tetrabromobisphenol-A ether, tetrabromobisphenol-bis(2-hydroxyethyl) ether, tetrabromobisphenol-S, tetrabromobisphenol-S bis(2,3-dibromopropyl ether), brominated epoxy oligomer, such as tribromophenol endcapped brominated epoxy oligomers, brominated carbonate oligomers based on tetrabromobisphenol-A such as 2,4,6-tribromophenyl terminated tetrabromobisphenol-A carbonate oligomer and phenoxy-terminated tetrabromobisphenol-A carbonate oligomer, brominated polystyrenes, block copolymers of polystyrene and brominated polybutadiene, poly(dibromophenylene oxide), poly(pentabromobenzyl acrylate), brominated phthalic acids, diallyl tetrabromophthalate, bis(2-ethylhexyl) tetrabromophthalate, tetrabromophthalimide, N,N-ethylene-bis(tetrabromophthalimide), tetrabromophthalic anhydride, a mixed ester of tetrabromophthalic anhydride with diethylene glycol and propylene glycol, N,N′-ethylene-bis-(5,6-dibromonorbornane 2,3-dicarboximide), tris(tribromophenyl)triazine, brominated phenoxytriazines such as tris(tribromophenoxy)triazine, brominated maleimides such as tribromophenyl maleimide, brominated trimethylphenylindan, brominated isocyanurates such as tris(2,3-dibromopropyl)isocyanurate, and tris(tribromoneopentyl) phosphate. Preferred brominated flame retardants to use in admixture with the brominated anionic styrenic polymers and/or brominated anionic chain transfer vinyl aromatic polymers include decabromodiphenyl ethane and N,N-ethylene-bis(tetrabromophthalimide).

In addition, to the brominated flame retardant discussed above, the embodiments of the present invention include a polymeric composition. The polymeric composition is useful as a thermoplastic material or thermoset material. The polymeric composition, together with the brominated flame retardant, provides a coating to wire and/or cable. Non-limiting examples of polymeric compositions that are useful as thermoplastics include polyurethanes, polyesters, polyamides, polyolefins, styrenic polymers, chlorinated polyethylene, and combinations thereof. Thermoset formulations for wire and/or cable are commonly formed by crosslinking technologies including (a) Moisture cure, (b) Peroxide cure, or (c) E-beam cure technologies. Non-limiting examples of base polymeric compositions suitable for cross-linking include polyolefins, such as polyethylene, and polyolefin copolymers such as poly(ethylene-vinyl acetate) (EVA) and poly(ethylene ethyl acrylate) (EEA), as well as derivatives of polyolefins such as chlorinated polyethylene or silane functionalized polyethylene.

Optional ingredients that can be present in the flame retardant compositions include inorganic compounds, antioxidants, impact modifiers, compatibilizers, halogenated polyethlyenes, pigments, flame retardant synergists, anti-dripping agents, dyes, light stabilizers, UV stabilizers, fillers, antifoaming agents, antimicrobial agents, biocidal agents, buffers, pH stabilizers, fixing agents, anti-static agents, soil repellants, water repellants, optical brighteners, plasticizers, emulsifiers, acid scavengers, radical scavengers, metal scavengers or deactivators, processing aids, mold release agents, lubricants, anti-blocking agents, antistatic agents, slip additives, blowing agents, antifogging agents, reinforcing agents, coupling agent, nucleating agents, other flame retardants, and other thermal stabilizers.

Preferred optional ingredients include inorganic compounds, antioxidants, impact modifiers, compatibilizers, halogenated polyethlyenes, and pigments. In some preferred embodiments, one or more antioxidants, one or more compatibilizers, one or more impact modifiers, one or more halogenated polyethlyenes, and/or one or more pigments are present in the additive composition. In some preferred embodiments, at least one inorganic compound and one or more other optional ingredients selected from antioxidants, impact modifiers, compatibilizers, and halogenated polyethlyenes are present in the flame retardant additive composition.

Inorganic compounds are a preferred type of optional ingredient. As used throughout this document, the phrase “inorganic component” refers to one or more inorganic compounds which contain one or more metal atoms that do not have a hydrocarbyl group bound directly to the metal atom(s). More preferably, at least one inorganic compound is present in the flame-retardant additive composition.

Suitable inorganic compounds, some of which function as synergists, in the practice of this invention include talc, ammonium phosphate, ammonium phosphinate, antimony trioxide, antimony pentoxide, antimony phosphate, aluminum phosphinate, aluminum diethyl phosphinate, sodium antimonate, calcium stearate, calcium borate, calcium phosphinate, magnesium hydroxide, magnesium aluminum hydroxide carbonate, zinc borate, zinc oxide, zinc stannate, zinc sulfide, zinc phosphate, zinc phosphinate, zinc diethyl phosphinate, zinc molybdate, tin (IV) oxide, titanium dioxide, titanium phosphate, α-zirconium phosphate, wollastonite, hydrotalcite, silane-modified aluminum silicate, glass fibers, and clays including smectites such as montmorillonite, bentonite, nontronite, hectorite, laponite, beidellite, volkonskoite, sauconite, stevensite, and saponite; kaolins such as halloysite; micas such as ledikite; rectorite; tarasovite; kenyaite; permutite; vermiculites; attapulgites; and illites. Mixtures of two or more inorganic compounds can be used if desired, and in some embodiments, more than one inorganic compound is preferred.

When present in the flame retardant composition, the inorganic compound(s) is about 10 wt % or more, preferably about 15 wt % or more, more preferably about 25 wt % or more, or about 10 wt % to about 70 wt %, preferably about 15 wt % to about 60 wt %, more preferably about 15 wt % to about 60 wt %, based on the total weight of the additive composition. When more than one inorganic compound comprises the inorganic component of the additive composition, these values refer to the combined amount of inorganic compounds present in the additive composition.

Antioxidants that can be used in the practice of this invention include phenolic antioxidants, thioesters, aromatic amines, phosphonites, and phosphite antioxidants. Suitable antioxidants include 2,6-di-tert-butyl-4-methyl phenol, tetrakis(3-(4-hydroxy-3,5-di-tert-butylphenyl)propionyloxymethyl) methane, 1,3,5-tris(3,5-di-tert-butyl-4-hydroxybenzyl)-s-triazine-2,4,6(1H,3H,5H)trione, octadecyl 3,5-di-tert-butyl-4-hydroxyhydrocinnamate, 1,3,5-trimethyl-2,4,6-tris(3,5-di-tert-butyl-4-hydroxybenzyl)benzene, 4,4′-methylenebis(2,6-di-tert-butyl-phenol), ethylenebis(oxyethylene)bis-(3-(5-tert-butyl-4-hydroxy-m-tolyl)-propionate), N,N′-(hexane-1,6-diyl)bis(3-(3,5-di-tert-butyl-4-hydroxypheny100propionamide), hexadecyl-3,5-di-t-butyl-4-hydroxybenzoate, 2,2′-thiodiethylene bis[3-(3,5-di-tert-butyl-4-hydroxyphenyl) propionate], C₁₃-C₁₅ linear and branched alkyl esters of 3-(3′5′-di-t-butyl-4′-hydroxyphenyl) propionic acid, C₉-C₁₁ linear and branched alkyl esters of 3-(3′,5′-di-t-butyl-4′-hydroxyphenyl) propionic acid, 2,2′-methylenebis(6-tert-butyl-4-methylphenol), 2,2′-ethylidenebis(4,6-di-tert-butylphenol), (1,1-di-tert-butyl)-4-hydroxyphenyl)methyl)ethylphosphonate, N-phenyl-benzenamine reaction products with 2,4,4-trimethylpentene, dimyristyl thiodipropionate, distearyldisulfide, pentaerythritol tetrakis(β-laurylthiopropionate), dioctadecyl 3,3′-thiodipropanoate, didodecyl 3,3′-thiodipropanoate, tris-(2,4-di-tert-butylphenyl)phosphite, bis(2,4-di-tert-butylphenyl)pentraerythritol diphosphate, (2,4,6-tri-tert-butylphenyl)(2-butyl-2-ethyl-1,3-propanediol)phosphite, tetrakis(2,4-di-tert-butylphenyl)-4,4′-biphenylene diphosphonite, distearylpentaerythritol diphosphite, bis(2,4-dicumylphenyl) pentaerythritol diphosphate, tris(dipropyleneglycol)phosphite, poly(dipropylene glycol) phenyl phosphite, diphenyl isodecyl phosphite, phenyl diisodecyl phosphite, heptakis (dipropyleneglycol) triphosphate, tris(nonylphenyl)phosphite, bis(2,6-di-tert-butyl-4-methylphenyl) pentaerythritol diphosphite, 2,2′-ethylidenebis(4,6-di-tert-butylphenyl) fluorophosphonite, 2,2′-methylenebis(4,6-di-tert-butylphenyl)octyl-phosphite, trilauryl trithiophosphite, 1,2-bis(3,5-di-tert-butyl-4-hydroxyhydrocinnamoyl) hydrazine, and 1:1:2 combination of calcium (3,5-di-tert-butyl-4-hydroxyphenyl)methyl ethoxyphosphinate, polyethylene wax and tris(2,4-di-tert-butylphenyl)phosphite. Mixtures of two or more antioxidants can be used. Preferred antioxidants include tetrakis(3-(4-hydroxy-3,5-di-tert-butylphenyl)propionyloxymethyl) methane and tris-(2,4-di-tert-butylphenyl)phosphite; more preferred is a combination of tetrakis(3-(4-hydroxy-3,5-di-tert-butylphenyl)propionyloxymethyl) methane and tris-(2,4-di-tert-butylphenyl)phosphite.

Generally, impact modifiers are rubbers or elastomers. Suitable impact modifiers in the practice of this invention include ethylene octene copolymers and ethylene hexene copolymers. Ethylene octene copolymers are preferred impact modifiers in the practice of this invention. Mixtures of impact modifiers can be used if desired.

Compatibilizers are sometimes thermoplastic elastomers, maleated copolymers of olefin homopolymers or copolymers, or in situ-formed macromolecule catalysts. Compatibilizers suitable for use in the practice of this invention include styrene ethylene butadiene copolymers, especially styrene ethylene/butylene linear triblock copolymers, maleic anhydride modified polypropylene homopolymers, and a sodium ionomer of ethylene/methacrylic acid copolymer. Mixtures of compatibilizers can be used. Preferred compatibilizers include styrene ethylene/butylene linear triblock copolymers.

Halogenated polyethylenes are polyethylenes containing halogen atoms. Suitable halogenated polyethylene includes polytetrafluoroethylene and chlorinated polyethylene. Mixtures of halogenated polyethylenes can be used.

Pigments are substances that impart coloration to a polymer, and are generally used only when a color for polymeric brominated flame retardant compositions for use in wire and/or cable is desired. Non-limiting examples of suitable pigments in the practice of this invention include a mixed oxide of chromium, antimony, and titanium (Brown 24), a mixed compound of chromium, nickel, and titanium (Yellow 53), 1,8-bis(phenylthio) anthracene-9,10-dione (Solvent Yellow 163), titanium dioxide, and carbon black, titanium dioxide, zinc sulphide, iron oxides, lead chromates and lead chromate molybdates, cadmium, chromium oxides. Mixtures of two or more pigments can be used.

Flame Retarded Polymeric Compositions for Use in Wire and/or Cable

One embodiment of the present invention is a flame retardant composition for use in wire and/or cable which comprises at least one polymeric composition; at least one brominated flame retardant; and at least one synergist in an amount greater than about 0.0 wt %; wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which have weight average molecular weights of about 650 to about 75,000 and which contains about 70 wt % or more bromine.

Optional ingredients that are often present in the flame retarded polyolefin compositions are as described above.

Suitable polymeric compositions are those polymeric composition useful as a thermoplastic material or thermoset material. Non-limiting examples of polymeric compositions that are useful as thermoplastics include polyurethanes, polyesters, polyamides, polyolefins, styrenic polymers, chlorinated polyethylene, and combinations thereof. Thermoset formulations for wire and/or cable are commonly formed by crosslinking technologies including (a) Moisture cure, (b) Peroxide cure, or (c) E-beam cure technologies. Non-limiting examples of base polymeric compositions suitable for cross-linking include polyolefins, such as polyethylene, and polyolefin copolymers such as poly(ethylene-vinyl acetate) (EVA) and poly(ethylene ethyl acrylate) (EEA), as well as derivatives of polyolefins such as chlorinated polyethylene or silane functionalized polyethylene.

The brominated flame retardants in the practice of this invention contain aromatically bound bromine, and in several embodiments are considered to be brominated styrenic polymers. The brominated flame retardants have weight average molecular weights (Mw) of about 650 to about 75,000 and a bromine content of about 60 wt % or more. Preferably, the styrenic polymers are polystyrenes. Mixtures of two or more brominated flame retardants can be used in the practice of this invention. Mixtures of brominated flame retardants and other non-halogenated flame retardants can also be used in practice of this invention.

In other embodiments, the brominated flame retardants are brominated anionic styrenic polymers, in which the styrenic polymers were formed via anionic polymerization, typically with an alkyl lithium initiator; these brominated flame retardants generally have a weight average molecular weight (Mw) of about 2000 or more, preferably about 10,000 or more. In some embodiments, the brominated anionic styrenic polymers have a Mw of about 8000 to about 50,000, preferably about 10,000 to about 30,000, and more preferably about 10,000 to about 20,000.

Typically, the brominated anionic styrenic polymers contain about 60 wt % or more bromine, preferably about 66 wt % or more bromine, more preferably about 67 wt % or more bromine. In some embodiments, the brominated anionic styrenic polymers contain about 60 wt % to about 72 wt % bromine, more preferably about 66 wt % to about 71 wt % bromine, even more preferably about 67 wt % to about 71 wt % bromine. Preferably, the brominated anionic styrenic polymer is a brominated anionic polystyrene. In some embodiments, the brominated anionic styrenic polymers are brominated anionic polystyrene having a weight average molecular weight of about 10,000 to about 20,000, and about 67 wt % to about 69 wt % bromine. Information on the preparation of brominated anionic styrenic polymers is found for example in U.S. Pat. Nos. 7,632,893 and 7,638,583.

In another embodiment, the brominated flame retardant is a low molecular weight brominated anionic styrenic polymer having a weight average molecular weight (Mw) of about 650 or more, preferably about 950 or more, more preferably about 1000 or more. In some embodiments, these brominated anionic styrenic polymers have an Mw in the range of about 650 to about 10,000, preferably about 750 to about 7500, and more preferably about 1000 to about 4000.

Typically, the low molecular weight brominated anionic styrenic polymers contain about 60 wt % or more bromine, preferably about 66 wt % or more bromine, more preferably about 70 wt % or more bromine. In some embodiments, these brominated anionic styrenic polymers contain about 60 wt % to about 77 wt % bromine, preferably about 66 wt % to about 77 wt %, more preferably about 70 wt % to about 75 wt % bromine.

Preferably, the low molecular weight brominated anionic styrenic polymers are brominated anionic polystyrenes. In some embodiments, the low molecular weight brominated anionic styrenic polymers are brominated anionic polystyrenes having a weight average molecular weight of about 1000 to about 3000, and about 73 wt % to about 77 wt % bromine.

The low molecular weight brominated anionic styrenic polymers can be formed by bromination in an organic solvent or in a sea of bromine (in which bromine is both the brominating agent and the solvent). Information on the preparation of low molecular weight brominated anionic styrenic polymers is found for example in International Patent Publications WO 2017/176740 and WO 2017/184350; these polymers can also be made as described U.S. Pat. Nos. 7,632,893 and 7,638,583.

Another brominated flame retardant that can be used in the practice of this invention is sometimes not categorized as a styrenic polymer due to the relatively small number of repeating units in these molecules. Similar to the brominated styrenic polymers, these molecules also contain aromatically-bound bromine, and styrenic repeating units. This brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more. In some embodiments, the bromine content is in the range of about 70 wt % to about 79 wt %, preferably about 72 wt % to about 78 wt %, and the Mw is in the range of about 1000 to about 21,000, preferably about 1250 to about 14,000, more preferably about 2000 to about 10,000.

Preferably, the brominated anionic chain transfer vinyl aromatic polymers are brominated anionic chain transfer polystyrenes. In some embodiments, the brominated anionic chain transfer vinyl aromatic polymers are brominated anionic chain transfer polystyrenes having a weight average molecular weight of about 2000 to about 10,000, and about 72 wt % to about 78 wt % bromine.

The brominated anionic chain transfer vinyl aromatic polymers can be formed by bromination in an organic solvent or in a sea of bromine (in which bromine is both the brominating agent and the solvent). Information on the preparation of brominated anionic chain transfer vinyl aromatic polymers is found for example in U.S. Pat. Nos. 8,420,876, 8,796,388, and 8,993,684.

Mixtures of two or more brominated flame retardants can be used in the practice of this invention. In addition to the brominated anionic styrenic polymers and/or brominated anionic chain transfer vinyl aromatic polymers, the flame retardant additive compositions can contain one or more other brominated flame retardants. Suitable brominated flame retardants include hexabromocyclohexane, dibromoethyldibromocyclohexane, monochloropentabromocyclohexane, tetrabromocyclooctane, hexabromocyclododecane, bis(pentabromophenyl)ethane (decabromodiphenyl ethane), hexabromobenzene, dibromostyrene and derivatives thereof, pentabromodiphenyl oxide, octabromodiphenyl oxide (octabromodiphenyl ether), decabromodiphenyl oxide (decabromodiphenyl ether), 1,2-bis(tribromophenoxy)ethane, tetradecabromodiphenoxybenzene, 2,4,6-tribromophenol allyl ether, dibromoneopentyl glycol, tribromoneopentyl alcohol, tetrabromobisphenol-A, tetrabromobisphenol A diallyl ether, tetrabromobisphenol-A bis(2,3-dibromopropyl ether), bis(2,4,6-tribromophenoxyethyl) tetrabromobisphenol-A ether, tetrabromobisphenol-bis(2-hydroxyethyl) ether, tetrabromobisphenol-S, tetrabromobisphenol-S bis(2,3-dibromopropyl ether), brominated epoxy oligomer, such as tribromophenol endcapped brominated epoxy oligomers, brominated carbonate oligomers based on tetrabromobisphenol-A such as 2,4,6-tribromophenyl terminated tetrabromobisphenol-A carbonate oligomer and phenoxy-terminated tetrabromobisphenol-A carbonate oligomer, brominated polystyrenes, block copolymers of polystyrene and brominated polybutadiene, poly(dibromophenylene oxide), poly(pentabromobenzyl acrylate), brominated phthalic acids, diallyl tetrabromophthalate, bis(2-ethylhexyl) tetrabromophthalate, tetrabromophthalimide, N,N-ethylene-bis(tetrabromophthalimide), tetrabromophthalic anhydride, a mixed ester of tetrabromophthalic anhydride with diethylene glycol and propylene glycol, N,N′-ethylene-bis-(5,6-dibromonorbornane 2,3-dicarboximide), tris(tribromophenyl)triazine, brominated phenoxytriazines such as tris(tribromophenoxy)triazine, brominated maleimides such as tribromophenyl maleimide, brominated trimethylphenylindan, brominated isocyanurates such as tris(2,3-dibromopropyl)isocyanurate, and tris(tribromoneopentyl) phosphate. Preferred brominated flame retardants to use in admixture with the brominated anionic styrenic polymers and/or brominated anionic chain transfer vinyl aromatic polymers include decabromodiphenyl ethane and N,N-ethylene-bis(tetrabromophthalimide).

Processes for Forming Flame Retarded Compositions for Use in Wire and/or Cable

One embodiment for a process for forming a flame retardant composition for use in wire and/or cable, which process comprises: A first step comprising of combining at least one polymeric composition; at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine; and at least one synergist and then extruding the mixture of the first step to coat a wire and/or cable

A further embodiment for a process for forming a flame retardant composition, which process comprises a first step comprising of combining at least one polymeric composition; at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine; and at least one organic peroxide. A second step of extruding the mixture of the first step to coat a wire and/or cable. And a third step of heating the coated wire and/or cable to a temperature above the decomposition point of at least one organic peroxide.

A further embodiment for a process for forming a flame retardant composition, which process comprises a first step comprising of combining at least one polymeric composition; at least one synergist; at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine. A second step of extruding the mixture of the first step to coat a wire and/or cable. And a third step of electron-beam irradiating the mixture of the coated wire and/or cable with an effective dose of electron-beam irradiation.

The brominated flame retardants and polymeric compositions include those discussed above. When preparing the compositions of this invention, the individual components can be blended separately and/or in subcombinations with the substrate or host polymer in appropriate proportions.

When the flame retarded polyolefin composition is formed from a flame retardant additive composition, the flame retardant additive composition is typically about 40 wt % or more of the flame retarded polyolefin composition, or about 40 wt % to about 80 wt % of the flame retarded polyolefin composition, based on the total weight of the flame retarded polyolefin composition.

Various methods can be used to prepare the compositions of this invention. The compounding of the brominated flame retardant, and the other ingredients can be done on compounding equipment such as a single screw extruder, a twin screw extruder, or a Buss kneader. Preferably, the compounding uses an extruder, more preferably a twin-screw extruder. The other ingredients utilized in the practice of this invention can be added in the initial feed port of the extruder or they can be added to the extruder further downstream. In an extruder, many ingredients typically melt as they are mixed together. The extrudate from the extruder is typically converted into granules or pellets either by cooling strands of the extruding polymer and subdividing the solidified strands into granules or pellets, or by subjecting the extrudate to concurrent die-faced pelletizing and water-cooling or air-cooling. If desired, the compositions of this invention can be formulated as powder or granular blends of the ingredients of the composition.

In certain embodiments, masterbatches comprising a polymeric composition and at least one brominated flame retardant can be formed. A masterbatch is usually a mixture having a high concentration of the brominated flame retardant relative to the thermoplastic. Normally, the masterbatch is later blended with more polymeric composition to form the product with the desired ratios of brominated flame retardant, other ingredients, and polymeric composition. Masterbatches can be used in thermoset formulations.

Forming the Coating of Wire and/or cable

In particular, these compositions of the present invention are useful as coatings for wire and/or cable. Fire retardants are used in wire and/or cable formulation to meet the flame performance required for the specific application such as appliances, building and construction, cables in automotives, photovoltaic wires, etc. In these applications, the insulation coating over the conductor is made to be flame retardant by incorporating various fire-retardant chemistries or technologies (Br, P, Metal hydroxide, etc.). Such fire-retardant chemistries are also used in the jacket (layer on top of insulation) formulation. The insulation or jacket could be (1) thermoplastic or (2) thermoset (crosslinked). Thermoplastic and thermoset formulation could have polyolefin (PP, PE) as the base polymer. Beyond polyolefin, the base polymer could also be polyurethane and chlorinated polyethylene. Polyolefin can be crosslinked typically by (a) Moisture cure, (b) Peroxide cure, (c) E-beam cure technologies.

Typically, the composition is prepared in a compounding extruder that mixes and evenly distributes and disperses all the ingredients. The extruded compound is then formed into pellets. Typically, pellets are then fed into a wireline extruder to coat the wire. For thermoset wire, the coated wire will be crosslinked in a second step based on the curing chemistry.

The curing chemistries suitable for the invention include curing by E-Beam and curing by peroxide. For peroxide cure, the wire would go through a continuous vulcanization tube at elevated temperature. For E-beam cure, the wire would go through a e-beam chamber.

For peroxide curing, any process known in the art would be suitable for this purpose. Typically and for example, the cure system can comprise an organic peroxide, such as 2,5-dimethyl-2,5-di-(tert-butylperoxy) hexane, dicumyl peroxide, VUL-CUP® or DiCup®, introduced into the blend at a temperature below a decomposition point of the peroxide, and the crosslinking can comprise heating the blend to a temperature above the decomposition point of the peroxide. The crosslinking in an embodiment can include a continuous vulcanization process downstream from an extruder. The crosslinking in another embodiment can comprise an Engel process wherein after the peroxide is introduced, the blend is rammed through a head maintained above the decomposition temperature of the peroxide to form a crosslinked extrudate.

For E-Beam curing, any process known in the art would be suitable for this purpose. For example, the method may comprise electron-beam irradiating the flame retardant composition with an effective dose of electron-beam irradiation. The effective or absorbed dose of electron-beam irradiation may be from 49 to 201 kilojoules energy per kilogram of EBC formulation (kJ/kg), alternatively from 49 to 160 kJ/kg, alternatively from 80 to 201 kJ/kg, alternatively from 80 to 160 kJ/kg, alternatively from 50 to 80 kJ/kg, alternatively from 100 to 140 kJ/kg, alternatively from 160 to 201 kJ/kg. 100 kJ/kg equals 10 megarad (Mrad)/kg equals 100,000 Gray. 1 Gray=1 Joule per kilogram (J/kg)=100 rad. The electron-beam irradiating step may be conducted at any suitable temperature such as from 10° to 50 °C (e.g., 23 °C±1 °C), under any suitable atmosphere such as air or molecular nitrogen gas. The irradiation may be dosed continuously or intermittently, alternatively continuously.

### EXAMPLES—GENERAL

### Ingredients

The ingredients used to make the flame retarded compositions are provided in the Examples. In the Tables, some of the ingredients used are referred to by their trade names.

### Analytical Methods

Known analytical methods can be used or adapted for use in assaying the characteristics of the brominated flame retardants and their polyolefin compositions used in the practice of this invention. The following methods were used to measure the brominated flame retardants, and/or the flame retarded polyolefin compositions formed, as applicable.

The analytical methods used or adapted to assay the polymeric BFRs have been described in WO 2022/031932 A1, which is incorporated herein by reference.

UL-VW-1 burn test. The VW-1 Burn Test is conducted by subjecting three or six samples of a specific coated conductor to the protocol of UL 2556. This involves five 15-second applications of a 125 mm flame impinging on at an angle 20° on a vertically oriented specimen 610 mm (24 in) in length. A strip of kraft paper 12.5±1 mm (0.5±0.1 in) is affixed to the specimen 254±2 mm (10±0.1 in) above the impingement point of the flame. A continuous horizontal layer of cotton is placed on the floor of the test chamber, centered on the vertical axis of the test specimen, with the upper surface of the cotton being 235±6 mm (9.25±0.25 in) below the point at which the tip of the blue inner cone of the flame impinges on the specimen. Test failure is based upon the criteria of either burning the 25% of the kraft paper tape flag, ignition of the cotton batting or if the specimen burns longer than 60 seconds on any of the five flame applications. As an additional measure of burn performance, the length of uncharred insulation (“no char to flag length”) is measured at the completion of the test. The VW-1 cotton ignited indicates if falling material ignited the cotton bed.

Each sample was formed by mixing and melting together all of the ingredients in a twin screw extruder (ZSK30 (30 mm), Werner & Pfleiderer Coperion GmbH), each ingredient being fed separately in powder form.

In all of the tables below, the amounts of each ingredient and the amount of bromine are reported as wt %.

### Example 1

Coated wire and/or cable formulations as shown in the below Table 1 were made according to the descriptions contained herein. 14 AWG tin-coated copper wire with 0.030-inch insulation was used for the wire construction. The brominated fire retardant coated wire was sent through a steam filled steel pipe of 60 feet in length to complete the peroxide curing process. The cured cable was then used for the tests below. Table 1 shows peroxide crosslinkable fire-retardant formulations. In Example 1 a polymeric brominated flame retardant is used according to the disclosures contained herein. Comparative 1 contains commercially available SAYTEX® 8010 small molecule brominated flame retardant. Example 2 used commercially available polymeric aromatic brominated flame retardant SAYTEX® HP 3010.

TABLE 1
Composition of peroxide curable fire retardant formulations

| Ingredients (wt %) | Comparative | Example 1-1 | Example 1-2 |
|---|---|---|---|
| ELVAX ™ 460 | 44.1 | 42.3 | 40.7 |
| SAYTEX ®-8010 | 15.9 | | |
| Polymeric Brominated Flame | | 17.7 | |
| Retardant | | | |
| SAYTEX ®-HP 3010 | | | 19.3 |
| Antimony trioxide (ATO) | 8.0 | 8.0 | 8.0 |
| Burgess KE | 15.7 | 15.7 | 15.7 |
| Sartomer 350 | 2.1 | 2.1 | 2.1 |
| IRGANOX ®1010 | 1.0 | 1.0 | 1.0 |
| VANOX ® ZMTI | 1.1 | 1.1 | 1.1 |
| Dynamar ™FX 5911 | 1.5 | 1.5 | 1.5 |
| Viton ™ FreeFlow 10 | 1.5 | 1.5 | 1.5 |
| Dow Corning ®MB50-002 | 3.0 | 3.0 | 3.0 |
| Paraffin wax | 2.5 | 2.5 | 2.5 |
| Zinc oxide (ZnO) | 2.60 | 2.60 | 2.60 |
| LUPEROX ® DHBP | 1.0 | 1.0 | 1.0 |
| (peroxide) | | | |
| Br wt % in the total | 13 | 13 | 13 |
| formulation | | | |

Table 2, below, shows the various
properties of peroxide cured wires

| Sample | Comparative | Example 1-1 | Example 1-2 |
|---|---|---|---|
| VW-1 | Pass | Pass | Pass |
| Tensile Strength (psi) | 1858 | 1609 | 1907 |
| Elongation at break (%) | 324 | 279 | 250 |
| Cold bend −25 °C and −40 °C | Pass | Pass | Pass |
| Crush resistance | Pass | Pass | Pass |

### Example 2

A second example of coated wire and/or cable was produced through E-Beam curing. 14 AWG copper wire with 0.030-inch insulation is used for the wire construction. The E-beam curable fire retardant formulations (table 3) were irradiated with 20 Mrad to produce the cured wires. The cured cables were then used for the tests below. Table 3 shows the various E-beam curable flame retardant formulations. And Table 4 shows the wire extrusion run condition, die pressure reading and wire surface quality. Comparative 1 is a commercially available SAYTEX®-8010 small molecule brominated flame retardant. Example 1 is a polymeric brominated flame retardant made according to the disclosures contained herein.

TABLE 3

| Ingredient (wt %) | Comparative | Example 2-1 |
|---|---|---|
| ExxonMobil ™ LDPE LD 201.48 | 52.5 | 46.0 |
| SAYTEX ®-8010 | 31 | |
| SAYTEX ®-HP 3010 | | 37.5 |
| Antimony trioxide (ATO) | 11.0 | 11.0 |
| VANOX ® ZMTI | 0.5 | 0.5 |
| A- ® 400 EVA | 2 | 2 |
| Zinc Stearate | 1.0 | 1.0 |
| Sartomer SR350 | 2 | 2 |
| Br wt % in the total formulation | 25.5 | 25.5 |

TABLE 4

| | Comparative | Example 2-1 |
|---|---|---|
| Zone 1 (°C) | 154 | 154 |
| Zone 2 (°C) | 160 | 160 |
| Zone 3 (°C) | 170 | 170 |
| Die (°C) | 170 | 170 |
| Melt Temp (°C) | 183 | 184 |
| RPM | 65 | 65 |
| Die Pressure (psi) | 1015 | 982 |
| Line Rate (m/min) | 5 | 5 |
| Surface Quality | Excellent | Excellent |

TABLE 5

| Sample | Comparative 1 | Example 2-1 |
|---|---|---|
| VW-1 | Pass | Pass |
| Hot Creep (150 °C, 0.2 MPa) % | 19 | 13 |

The process condition shows benefit of having Example 2 as it provides lower die pressure during the wire extrusion while maintaining key VW-1 and hot creep performance. Such improvement is important for customer for lower energy use and possibility for higher line speed (higher throughput).

### Example

An example of coated wire and/or cable was produced through E-Beam curing. 14 AWG tin-coated copper wire with 0.030-inch insulation is used for the wire construction. The E-beam curable fire retardant formulations (table 3) were irradiated with 15 Mrad to produce the cured wires. The cured cables were then used for the tests below. Table 6 shows the various E-beam curable flame retardant formulations. And Table 7 shows the wire extrusion run condition, die pressure reading and wire surface quality. The comparative is a commercially available SAYTEX®-8010 small molecule brominated flame retardant. Examples 3-1-3-5 use a polymeric brominated flame retardant made according to the disclosures contained herein.

TABLE 6

| | | Example | Example | Example | Example | Example |
|---|---|---|---|---|---|---|
| Ingredient (wt %) | Comparative | 3-1 | 3-2 | 3-3 | 3-4 | 3-5 |
| EM LDPE LD 201.48 | 54.5 | 46.6 | 23.3 | 42.0 | 21.0 | 36.8 |
| EVA LYONDELL BASELL UE624000 | | | 23.3 | | 21.0 | 12.6 |
| SAYTEX 8010 | 31.0 | | | | | |
| Polymeric Brominated Flame Retardant | | 34.9 | 34.9 | 38.4 | 38.4 | 28.0 |
| SICA ATO | 11.0 | 11.0 | 11.0 | 12.1 | 12.1 | 15.2 |
| Vanox ZMTI | 0.5 | 0.5 | 0.5 | 0.5 | 0.5 | 0.5 |
| Zinc Stearate | 1.0 | | | 5.0 | | |
| ZnO | | 5.0 | 5.0 | | 5.0 | 5.0 |
| Sartomer SR350 | 2.0 | 2.0 | 2.0 | 2.0 | 2.0 | 2.0 |
| Br wt % total formulation | 25.5 | 25.5 | 25.5 | 28.0 | 28.0 | 20.5 |

TABLE 7

| | | Example | Example | Example | Example | Example |
|---|---|---|---|---|---|---|
| Temp (oC) | Comparative | 3-1 | 3-2 | 3-3 | 3-4 | 3-5 |
| Zone-1 | 154 | 154 | 154 | 154 | 154 | 154 |
| Zone-2 | 160 | 160 | 160 | 160 | 160 | 160 |
| Zone-3 | 170 | 170 | 170 | 170 | 170 | 170 |
| Zone-4 | | | | | | |
| Die | 170 | 170 | 170 | 170 | 170 | 170 |
| Melt temp (oC) | 185 | 185 | 185 | 185 | 185 | 185 |
| RPM | 65 | 65 | 65 | 65 | 65 | 65 |
| Die pressure (psi) | 890 | 943 | 1183 | 800 | 1180 | 1105 |
| Line Rate (m/min) | 5 | 5 | 5 | 5 | 5 | 5 |
| Surface Quality | Excellent | Excellent | Excellent | Shark | Excellent | Excellent |
| | | | | skin | | |

TABLE 8

| | Comparative | Example | Example | Example | Example | Example |
|---|---|---|---|---|---|---|
| Ingredient | 1 | 3-1 | 3-2 | 3-3 | 3-4 | 3-5 |
| VW-1 | Fail | Fail | Pass | — | Pass | Fail |
| Hot Creep | — | — | 19.7 | — | 19.4 | — |

### Example 4

An example of coated wire and/or cable was produced through E-Beam curing. 14 AWG tin-coated copper wire with 0.030-inch insulation is used for the wire construction. The E-beam curable fire retardant formulations (table 3) were irradiated with 15 Mrad to produce the cured wires. The cured cables were then used for the tests below. Table 9 shows the various E-beam curable flame retardant formulations. And Table 10 shows the wire extrusion run condition, die pressure reading and wire surface quality. Comparative is a commercially available SAYTEX®-8010 small molecule brominated flame retardant. The Examples use a polymeric brominated flame retardant made according to the disclosures contained herein.

TABLE 9

| | | Example | Example | Example | Example | Example | Example |
|---|---|---|---|---|---|---|---|
| | Comparative | 4-1 | 4-2 | 4-3 | 4-4 | 4-5 | 4-6 |
| EM LDPE LD 201.48 | 28.1 | 25.6 | 25.8 | 24.8 | | 35.0 | 23.8 |
| EVA LYONDELL | 28.1 | 25.6 | 25.8 | 24.8 | 45.5 | 11.6 | 23.8 |
| BASELL UE624000 | | | | | | | |
| Polymeric Brominated | 31.0 | 31.0 | 34.9 | 34.9 | 34.9 | 34.9 | 34.9 |
| Flame Retardant | | | | | | | |
| SICA ATO | 10.3 | 10.3 | 11.0 | 11.0 | 12.1 | 11.0 | 11.0 |
| Vanox ZMTI | 0.5 | 0.5 | 0.5 | 0.5 | 0.5 | 0.5 | 0.5 |
| ZnO | | 5.0 | | 2.0 | 5.0 | 5.0 | 5.0 |
| Sartomer SR350 | 2.0 | 2.0 | 2.0 | 2.0 | 2.0 | 2.0 | 1.0 |
| Br % | 22.6 | 22.6 | 25.5 | 25.5 | 25.5 | 25.5 | 25.5 |

TABLE 10

| | | Example | Example | Example | Example | Example | Example |
|---|---|---|---|---|---|---|---|
| Temp (oC) | Comparative | 4-1 | 4-2 | 4-3 | 4-4 | 4-5 | 4-6 |
| Zone-1 | 115 | 115 | 115 | 115 | 115 | 115 | 115 |
| Zone-2 | 120 | 120 | 120 | 120 | 120 | 120 | 120 |
| Zone-3 | 140 | 140 | 140 | 140 | 140 | 140 | 140 |
| Die | 140 | 140 | 140 | 140 | 140 | 140 | 140 |
| Melt temp (oC) | 150 | 151 | 151 | 151 | 151 | 151 | 151 |
| RPM | 65 | 65 | 65 | 65 | 65 | 65 | 65 |
| Die pressure (psi) | 2000 | 2091 | 2100 | 2150 | 2500 | 2300 | 2350 |
| Line Rate (m/min) | 5 | 5 | 5 | 5 | 5 | 5 | 5 |
| Surface Quality | Excellent | Excellent | Excellent | Excellent | Excellent | Excellent | Excellent |
| Conductor Centering | OK | OK | OK | OK | OK | OK | OK |

TABLE 11

| | Example | Example | Example | Example | Example | Example |
|---|---|---|---|---|---|---|
| | 4-1 | 4-2 | 4-3 | 4-4 | 4-5 | 4-6 |
| Cold Bend (−40 °C) | Pass | Pass | Pass | Pass | Pass | Pass |
| Hot Creep (Ave %) | 18.4 | 22.4 | 2 | 12.4 | 21.3 | 17.9 |
| STD | 0.6 | 1.7 | 3 | 1.1 | 0.1 | 1.3 |
| Tensile | 1581 | 1545 | 1534 | 2328 | 1752 | 1575 |
| STD | 45 | 35 | 22 | 87 | 49 | 24 |
| Crush | 3.85 | 4.65 | | 4.63 | 3.67 | 3.82 |
| STD | 0.51 | 0.87 | | 0.88 | 0.90 | 0.60 |

### Example 5

An example of compounded flame retardant and polypropylene is shown below. The compound was manufactured according to the disclosure contained herein. The PP-BFR formulations above were compounded in a 30 mm twin screw extruder at 200 °C at 175 rpm. The compounded materials were cooled and stand pelletized. The BFR wt % was adjusted to keep a constant Br % (16.5) for each formulation.

| | Example | Example | Comparative | Comparative | Comparative |
|---|---|---|---|---|---|
| Ingredient | 5-1 | 5-2 | 5-1 | 5-2 | 5-3 |
| Pro-fax 257M | 66.2 | 64.9 | 64.9 | 68.9 | 64.4 |
| (Polypropylene) | | | | | |
| Polymeric Brominated | 22.8 | | | | |
| Flame Retardant | | | | | |
| HP 3010 | | 24.0 | | | |
| HP-7010 | | | 24.0 | | |
| S-8010 | | | | 20.0 | |
| BT-93W | | | | | 24.5 |
| ATO | 11.0 | 11.0 | 11.0 | 11.0 | 11.0 |
| Ir1010 (antioxidant) | 0.1 | 0.1 | 0.1 | 0.1 | 0.1 |

### Example 6

An example of coated wire and/or cable was produced through and utilized in polypropylene cable insulation. The insulation was manufactured according to the disclosure contained herein. Each of the examples from Example 5 was used herein. 30 mil of insulation of the BFR-PP compound was extruded on a 14 AWG copper wire using a 0.75 inch single screw extruder with 3:1 Maddock screw head with 5 meters per minute line rate. The produced wires were analyzed. As can be seen in the Table below, it is noted that the BFR of current invention offers the following benefits:
1. 30% lower die pressure indicating better melt flow than non-polymeric BFRs.
2. offers Horizontal burn performance as compared to commercially available S-8010/BT-93W
3. While all BFRs offer>10 KN (max limit of the instrument) of crush performance. The current invention offers better crush performance.

| Data collected on 14 | | | | | |
|---|---|---|---|---|---|
| AWG/30 mil wire, 5 | | Example 6- | Comparative | Comparative | Comparative |
| meter/min | Example 6-1 | 2 | 6-1 | 6-2 | 6-3 |
| Br % | 16.5 | 16.5 | 16.5 | 16.5 | 16.5 |
| Melt temp (°C) (wire | 238 | 238 | 238 | 238 | 238 |
| extrusion) | | | | | |
| Die pressure (psi) | 843 | 920 | 1480 | 1260 | 1300 |
| Surface smoothness | Excellent | Excellent | Rough | Excellent | Excellent |
| Horizontal burn | Pass | Pass | Fail | Fail | Fail |
| Char length (inch) | 3.41 | 2.75 | 3.33 | 3.66 | 6.16 |
| After flame (sec) | 74.4 | 57.4 | 60 | 36 | 153 |
| Elongation at break | 425 | 299 | 36 | 864 | 503 |
| (%) | | | | | |
| Tensile strength (psi) | 3778 | 3749 | 2819 | 3722 | 3848 |
| Tensile strength at | 1993 | 1282 | 1629 | 2366 | 2191 |
| break (psi) | | | | | |
| Crush | >10 KN | >10 KN | >10 KN | >10 KN | >10 KN |

### Example 7

An example of coated wire and/or cable was produced through and utilized in thermoplastic cable sheathing. The sheathing was manufactured according to the disclosure contained herein. TPU-BFR compounds were produced on the WP twin screw extruder at 200 °C, 200 rpm. Polymeric BFRs and non-polymeric (S-8010, BT-93W) BFRs were used in the formulation, keeping the Br % (16.5%) and Br/ATO ratio constant.

| | Example | Example | Comparative | Comparative | Comparative |
|---|---|---|---|---|---|
| Ingredient | 7-1 | 7-2 | 1 | 2 | 3 |
| Desmopan ® | 66.1 | 64.9 | 64.9 | 68.9 | 64.4 |
| 9386A (TPU) | | | | | |
| Polymeric | 22.8 | | | | |
| Brominated Flame | | | | | |
| Retardant | | | | | |
| HP 3010 | | 24.0 | | | |
| HP-7010 | | | 24.0 | | |
| S-8010 | | | | 20.0 | |
| BT-93W | | | | | 24.5 |
| ATO | 11.0 | 11.0 | 11.0 | 11.0 | 11.0 |
| Ir1010 | 0.1 | 0.1 | 0.1 | 0.1 | 0.1 |

### Example 9

An example of thermoplastic tapes was produced. The TPU-FR pellets compounded on the WP were dried at 100 °C for 4 h before producing the tape in the single screw extruder. Produced tapes out of TPU-BFR compounds: Single screw extruder conditions used: 0.75 inch single screw extruder with 2:1 PE screw; 160 °C/190 °C/190 °C/190 °C; 20/40/20 screen pack; 45 rpm; 30 mil tape thickness. As can be seen below, the BFR of the current invention offers better elongation at break, and better tear strength than non-polymeric S-8010 while providing the V2 flame performance.

| | Example | | | |
|---|---|---|---|---|
| | 1 | | | |
| | Polymeric | Example | Compar- | Compar- |
| | Brominated | 2 | ative | ative |
| | Flame | HP- | 1 | 2 |
| Properties | Retardant | 3010 | HP-7010 | S-8010 |
| Tear Strength | 429 | 312 | 335 | 393 |
| (lb/in) (20 | | | | |
| inch/min) | | | | |
| UL-94 flame test | V2 | V2 | V2 | V2 |
| (30 mil) | | | | |
| Elongation at | 609 | 539 | 601 | 500 |
| break (%) | | | | |
| Tensile | 920 | 740 | 1032 | 932 |
| strength at | | | | |
| 50% strain (psi) | | | | |

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A flame retardant composition for use in wire and/or cable which comprises
at least one polymeric composition;
at least one brominated flame retardant; and
at least one synergist in an amount greater than about 0.0 wt %;
wherein the brominated flame retardant contains aromatically-bound bromine and is selected from a) brominated styrenic polymers which have weight average molecular weights of about 650 to about 75,000 and a bromine content of about 60 wt % or more,
and/or b) a brominated anionic chain transfer vinyl aromatic polymer which have weight average molecular weights of about 650 to about 75,000 and which contains about 70 wt % or more bromine.

2. The flame retardant composition of claim 1 wherein brominated flame retardant has a weight average molecular weight (Mw) of about 2000 to about 50,000, preferably about 8000 to about 50,000, more preferably about 10,000 to about 30,000, and most preferably about 10,000 to about 20,000.

3. The flame retardant composition of claim 1 wherein the brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more.

4. The flame retardant composition of claim 1 wherein brominated flame retardant has a bromine content of about 67 wt % or more, more preferably about 68 wt % or more.

5. The flame retardant composition of any of claim 1, wherein the polymeric composition comprises polyurethane, polyester, polyamide, polyolefin, styrenic polymer, chlorinated polyethylene, and/or combinations thereof.

6. The flame retardant composition of claim 1, wherein the polymeric composition comprises polyolefin, such as polyethylene, and polyolefin copolymers such as poly(ethylene-vinyl acetate) (EVA) and poly(ethylene ethyl acrylate) (EEA), as well as derivatives of polyolefins such as chlorinated polyethylene or silane functionalized polyethylene.

7. The flame retardant composition of any of claims 1-8 further comprising an organic peroxide.

8. The flame retardant composition of claim 9 wherein the organic peroxide comprises dicumyl peroxide or 2,5-dimethyl-2,5-di-(tert-butylperoxy)hexane.

9. The flame retardant composition of any of claims 1-8 wherein the synergist comprises antimony oxide.

10. A coated wire and/or cable wherein the coating is comprised of a flame retardant composition of any of the preceding claims.

11. A process for forming a flame retardant composition for use in wire and/or cable, which process comprises:
A first step comprising of combining
i. at least one polymeric composition;
ii. at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine; and
iii. at least one synergist;
A second step of extruding the mixture of the first step to coat a wire and/or cable.

12. The process for forming a flame retardant composition of claim 11 wherein brominated flame retardant has a weight average molecular weight (Mw) of about 2000 to about 50,000, preferably about 8000 to about 50,000, more preferably about 10,000 to about 30,000, and most preferably about 10,000 to about 20,000.

13. The process for forming a flame retardant composition of claim 11 wherein the brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more.

14. The process for forming a flame retardant composition of claim 11 wherein brominated flame retardant has a bromine content of about 67 wt % or more, more preferably about 68 wt % or more.

15. The process for forming a flame retardant composition of any of claims 11-14 wherein the synergist comprises antimony oxide.

16. A process for forming a flame retardant composition, which process comprises:
(a) A first step comprising of combining
i. at least one polymeric composition;
ii. at least one synergist;
iii. at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine; and
iv. at least one organic peroxide
(b) A second step of extruding the mixture of the first step to coat a wire and/or cable
(c) A third step of heating the coated wire and/or cable to a temperature above the decomposition point of the at least one organic peroxide.

17. The process for forming a flame retardant composition of claim 16 wherein brominated flame retardant has a weight average molecular weight (Mw) of about 2000 to about 50,000, preferably about 8000 to about 50,000, more preferably about 10,000 to about 30,000, and most preferably about 10,000 to about 20,000.

18. The process for forming a flame retardant composition of claim 16 wherein the brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more.

19. The process for forming a flame retardant composition of claim 16 wherein brominated flame retardant has a bromine content of about 67 wt % or more, more preferably about 68 wt % or more.

20. The process for forming a flame retardant composition of any of claims 16-19 wherein the synergist comprises antimony oxide.

21. The process for forming a flame retardant composition of any of claims 16-20 wherein the the organic peroxide comprises dicumyl peroxide or 2,5-dimethyl-2,5-di-(tert-butylperoxy)hexane.

22. A process for forming a flame retardant composition, which process comprises:
(a) A first step comprising of combining
i. at least one polymeric composition;
ii. at least one synergist;
iii. at least one brominated flame retardant wherein the brominated flame retardant contains aromatically-bound bromine and is selected from a) brominated styrenic polymers which have weight average molecular weights of about 650 to about 75,000 and a bromine content of about 60 wt % or more, and/or b) a brominated anionic chain transfer vinyl aromatic polymer which contains about 70 wt % or more bromine;
(b) A second step of extruding the mixture of the first step to coat a wire and/or cable
(c) A third step of electron-beam irradiating the mixture of the coated wire and/or cable with an effective dose of electron-beam irradiation.

23. The process for forming a flame retardant composition of claim 22 wherein brominated flame retardant has a weight average molecular weight (Mw) of about 2000 to about 50,000, preferably about 8000 to about 50,000, more preferably about 10,000 to about 30,000, and most preferably about 10,000 to about 20,000.

24. The process for forming a flame retardant composition of claim 22 wherein the brominated flame retardant is a brominated anionic chain transfer vinyl aromatic polymer which contains about 70 wt % or more bromine, preferably about 72 wt % or more bromine, and a weight average molecular weight of about 1000 or more, preferably about 1250 or more.

25. The process for forming a flame retardant composition of claim 22 wherein brominated flame retardant has a bromine content of about 67 wt % or more, more preferably about 68 wt % or more.

26. The process for forming a flame retardant composition of any of claims 22-26 wherein the synergist comprises antimony oxide.

27. A coated wire and/or cable wherein the coating is comprised of a flame retardant composition of made from processes any of claims 11-26.
